(19) United States
(12) Patent Application Publication
(10) Pub. No.: US 2001/0035690 A1
(43) Pub. Date: Nov. 1, 2001

(54) Magneto-cumulative generator performance by using variable bitter coil-type stator windings

(76) Inventors: Keith G. Kato, Alta Loma, CA (US); David D. Crouch, Corona, CA (US); David R. Sar, Corona, CA (US)

Correspondence Address: RAYTHEON COMPANY, P.O. Box 902, EO/E1/E150, El Segundo, CA, 90245-0902, US

(21) Appl. No.: 09/793,358

(22) Filed: Feb. 26, 2001

Related U.S. Application Data
(63) Continuation-in-part of application No. 08/982,067, filed on Dec. 1, 1997, now abandoned.

(51) Int. Cl. H02K 1/00; H02K 3/00

(52) U.S. Cl. 310/179; 310/10

(57) ABSTRACT

An explosively-driven magneto-cumulative generator that employs a Bitter coil with configurable electromagnet windings and insulation in its stator. An armature with a conducting metal liner filled with high explosive is initiated by an initiator and a switchable seed capacitor. The stator is coaxially aligned with and surrounds the armature and comprises the Bitter coil. A load is coupled between the armature and the Bitter coil. The Bitter coil comprises a series of conducting annular disks with an azimuthal sector of conductor removed. The disks are stacked with interleaved insulation, and are connected turn-by-turn. The windings of the Bitter coil can be modified, turn-by-turn, to change the inner and outer radii, and thickness, of each winding, and the material, size, and spacing of the interleaving insulation. This design variability solves many performance problems of conventional magneto-cumulative generators.

### CROSS-REFERENCE TO RELATED APPLICATION

The present application is a continuation-in-part of application Ser. No. 08/982,067, filed Dec. 1, 1997.

### TECHNICAL FIELD

The present invention relates generally to explosively-driven magneto-cumulative generators (also known as flux compression generators), and more particularly, to improving the performance of extant magneto-cumulative generator designs by employing variable Bitter coil-type stator windings.

### BACKGROUND ART

The prior art of magneto-cumulative generators can be found in research papers published in proceedings such as the IEEE Pulsed Power Conference or the International Megagauss Conference, and in a comprehensive current-state-of-knowledge book for students and researchers in the field of magneto-cumulative generator research that was recently published (Larry L. Altgilbers, Mark D. J. Brown, Igor Grishnaev, Bucur M. Novac, Ivor R. Smith, laroslave Tkach, and Yuriy Tkach, editors, Magnetocumulative Generators, Springer-Verlag New York, Inc., New York, 2000). The use of a variable Bitter coil-type stator winding for a magneto-cumulative generator should inherently raise the energy conversion efficiency of magneto-cumulative generators, possibly raise the total output energy (both in voltage and current) that could be produced, and would permit “tailoring” of the pulse shape characteristics of the output waveform due to the turn-by-turn modification capability inherent in Bitter coil designs.

In prior magneto-cumulative generator designs, an initial magnetic field is created using electrical current flowing through solenoidal-type wire windings. Unless special wire is drawn and used, normal wire has a constant geometric size, shape, cross-sectional area, and insulation thickness. Typically, this solenoidal winding (the “stator”) is the external component of a coaxial concentric structure. The internal component of the coaxial structure (the “armature”) is a hollow conducting cylinder through which the return current from the stator flows. This construction results in some portion of the initial magnetic field contained in the annular volume between the stator and armature. The armature contains chemical high explosive, which when initiated first expands the armature radially into contact with the stator. The detonation front in the explosive also propagates axially from “upstream” to “downstream”, progressively moving the contact point of the armature against the stator in the downstream direction. The chemical energy of the explosive converts to kinetic energy of the armature, which then does work against the magnetic field between the stator and armature. This work results in higher output electrical energy (both in voltage and current) delivered into the immediate electrical load of the magneto-cumulative generator.

One disadvantage of the prior magneto-cumulative generator art is the low (on the order of 1 percent) conversion efficiency from explosive energy to electrical energy. This inefficiency originates in part from magnetic flux losses through various mechanisms such as loss through the insulation gaps between windings, “clocking” gaps as the armature-stator contact point follows the pitch of the stator winding, and electrical losses such as Joule heating in conductors. The tightly-spaced nature of a Bitter coil winding lends itself to inhibiting flux losses between windings, while providing more conducting area only where it is needed, thus reducing Joule heating losses. The perpendicular alignment of Bitter coil windings with respect to the axis results in zero winding pitch, hence no clocking. At present, the low magneto-cumulative generator efficiency is accepted as a “fact of life”.

A second disadvantage of the prior magneto-cumulative generator art is that the use of constant cross-sectional area wire for the stator of the magneto-cumulative generator artificially limits the current-handling capacity of the stator, requiring “overkill”current capacity for the upstream early turns to obtain adequate current capacity for the downstream late turns. This feature places some limits on the magnitude of energy to be extracted from magneto-cumulative generators. At present, the only method of achieving greater current capacity in the late turns is to make “bifilar” windings, where at some intermediate break point(s) one wire ends but is electrically connected to two new wires, which are used to sustain the downstream winding pattern. Bifilar multiplication of the current handling capacity is inelegant, and offers only quantized increases in current capacity, whereas Bitter coil windings provide for programmed, incremental increases in current capacity.

A third disadvantage of the prior magneto-cumulative generator art is that the final output voltage is limited by the thickness of insulation available on standard wire. The increasing output voltage developed as the armature contact point moves downstream is inductively graded across the remaining downstream turns of the stator. Thus as the magnitude of the final voltage increases, constituent turn-to-turn voltages also increases on progressively fewer remaining downstream turns. At some point the extremely high voltage developed will puncture the insulation between remaining turns, limiting the final output voltage. Normal, commercially available insulated wire typically comes with one established insulation thickness, whereas Bitter coil windings provide for programmed, incremental increases in insulation, especially between the downstream late turns.

A fourth disadvantage of the prior magneto-cumulative generator art is that the only design approach to tailor the stator profile is to wind the stator on a geometrically-changing profile such as a conical surface. While this method has produced some performance advantage, it does not lend itself to the design variability that a Bitter coil can produce: changing inner and outer radii, changing winding thickness, changing turn-to-turn insulation.

A fifth disadvantage of the prior magneto-cumulative generator art is that construction of a solenoidal stator winding is labor-intensive and, even if performed either automatically or by an experienced technician, is prone to detrimental variations within production lots. The Bitter coil approach reduces manufacturing variability by permitting each constituent within the coil to be mass-produced to tight tolerances.

A search was performed relating to the present invention and a number of U.S. patents were uncovered that disclose various types of devices relating to magneto-cumulative generators.

U.S. Pat. No. 4,370,576 entitled “Electric generator” discloses the fundamental invention claims of the magneto-cumulative generator.

U.S. Pat. No. 3,564,305 entitled “Method and apparatus for creating pulsed magnetic field in a large volume” discloses the design of a low resistance, low inductance hollow segmented cylindrical load used to create a momentary, pulsed, high magnitude magnetic field within the cylinder. The load uses a magneto-cumulative generator as the source of electrical energy.

U.S. Pat. No. 4,862,085 entitled “Method of regulating the magnetic field delivered by a resistive magnet” discloses a resistive magnet system using this method and an installation for forming images by nuclear magnetic resonance incorporating such a system. A system for regulating the field of a high homogeneity magnet is also disclosed. The fluid used for cooling the main magnet is placed in thermal contact with a high homogeneity auxiliary magnet in which is placed a nuclear magnetic resonance (NMR) probe that controls the current supply to the two magnets connected in series.

U.S. Pat. No. 4,774,487 entitled “Solenoidal magnet with high magnetic field homogeneity” discloses a structure for connection between spaced Bitter coils in a magnet with homogeneous field. The magnet is formed of several Bitter coils spaced apart from each other and two adjacent coils are connected together by two groups of conductors symmetrical with respect to a plane and in which the current components create ampere turns in opposition.

U.S. Pat. No. 4,748,429 entitled “Solenoidal magnet with homogeneous magnetic field” discloses a resistive solenoid magnet with homogeneous field more particularly for NMR image formation. In this apparatus, the magnet comprises several coils preferably Bitter coils and some parameters such as the lengths of the coils, the distances which separate them and their outer diameter are chosen for optimizing the power-mass product of the magnet.

U.S. Pat. No. 4,745,387 entitled “Coil connection for an ironless solenoidal magnet” discloses a structure for connecting the disks of a Bitter coil. The disks each include a cut out in the form of a slit, for example undulating so as to define from one disk to another zones with overlapping of turns divided into two groups and the electric connections are provided by junctions of said overlapping zones of one group or the other, alternatively from one disk to another.

U.S. Patent No. 4,736,176 entitled “Transition disk in a solenoidal magnet with Bitter type annular disks” discloses a structure for connection between Bitter coils in a magnet with homogeneous field. The magnet is formed of several Bitter coils joined side by side and whose disks are of different thicknesses and two adjacent coils are connected together by a transition disk forming a turn and having for example a set-back on each of its faces for adapting it to the different thicknesses of the disks of two coils.

U.S. Pat. No. 4,823,101 entitled “Method of manufacturing a Bitter type coil and a solenoid magnet obtained thereby” discloses a method for manufacturing a Bitter coil by indium welding and a solenoid magnet obtained by using this method. The Bitter disks or parts of such disks are welded with an indium filler, deposited preferably electrolytically on the portions to be assembled together.

U.S. Pat. No. 4,808,956 entitled “Coreless solenoidal magnet” discloses a coreless solenoidal magnet formed by a Bitter coil with improved field homogeneity. According to the invention the tie rods of the stack of disks are used for bringing the current back towards one of the axial ends of the magnet without creating a parasite field.

U.S. Pat. No. 4,743,879 entitled “Solenoidal magnet with high magnetic field” discloses a solenoidal magnet with high magnetic field homogeneity, including a connection structure between spaced coils. The current between two adjacent spaced coils is transmitted in one direction by a longitudinal conductor and in the other direction by two longitudinal conductors disposed on each side of said first conductor.

U.S. Pat. No. 4,727,326 entitled “Method and device for forming images by nuclear magnetic resonance” discloses a method and device for forming images by nuclear magnetic resonance in which an image is constructed by discrimination of the intrinsic parameters of tissues that are examined. The image is formed by putting forward the degrees of attachment and mobility of the nuclei of the tissues. The parameters displayed represent the field heterogeneities at the microscopic and molecular levels. The method consists in acquiring a first image using conventional methods then, after slightly varying the orienting magnetic field, in acquiring another image using the same methods. Then an image of another type is formed by representing the relative variations of the relaxation times between this first and this second image.

Accordingly, it is an objective of the present invention to provide for an improved magneto-cumulative generator employing Bitter coil-type stator.

### DISCLOSURE OF INVENTION

To meet the above and other objectives, the present invention provides for explosively-driven magneto-cumulative generators that employ Bitter coil-type electromagnet windings in its stator to improve performance. Bitter coils are a series of conducting annular disks with a small azimuthal sector of conductor removed. The disks are stacked with interleaved insulation, and are overtly connected turn-by-turn at the slots. The novel feature of using Bitter coil-type electromagnet windings in the stator of the magneto-cumulative generator is that the Bitter coil can be modified, turn-by-turn, to change the thickness and inner and outer radii, of each winding, and the material, size, and spacing of the interleaving insulation. This design variability is not normally used in standard Bitter coil construction. This design variability over solenoidal wire windings solves many performance problems of conventional magneto-cumulative generators.

More specifically, the present magneto-cumulative generator comprises an armature having a conducting metal liner filled with high explosive, and an initiator disposed at one end of the high explosive. A stator that comprises a Bitter coil is coaxially aligned with and surrounds the armature. The Bitter coil comprises a plurality of disk-like windings interconnected by turn-to-turn connecting elements, and insulation disposed between the respective windings. A switchable seed capacitor is coupled between the Bitter coil and the initiator, and a load is coupled between the armature and the Bitter coil.

The present invention provides greater operating efficiency and design variability by replacing the solenoidal windings of a magneto-cumulative generator stator with Bitter coil-type windings. The advantages of the Bitter coil for a magneto-cumulative generator are: increased initial inductance in the stator, increased, adjustable, variable, pre-tailored time rate of change of inductance (dL/dt) of the stator during collapse, less flux lost through diffusion, less flux lost through insulating gaps between turns, less flux lost through “clocking”, and ease of manufacture.

The use of a Bitter coil as a design strategy also lends itself to other advantages in magneto-cumulative generator design. For example, progressively greater turn-to-turn voltage insulation for the downstream stator windings as the stator length effectively shortens, progressively greater current-carrying capacity for the downstream stator windings as the stator length effectively shortens, ability to tailor the inductance (hence also the time rate of change of the inductance) profile of the stator; ability to vary the pitch of the stator windings, and other “mix and match” stator winding approaches, such as progressively changing the thickness and inner and outer diameters of the conducting disks, and progressively changing the thickness and inner and outer diameters of the insulation along the stator length.

The present invention increases the energy conversion efficiency of magneto-cumulative generators, thereby reducing the necessary volume and weight for that component in military systems. Magneto-cumulative generators are capable of momentarily producing over 10⁷ amperes of current, which may have potential utility in specialized commercial activities such as ore fracturing, for example.

### BRIEF DESCRIPTION OF THE DRAWINGS

The various features and advantages of the present invention may be more readily understood with reference to the following detailed description taken in conjunction with the accompanying drawings, wherein like reference numerals represent like structural elements, and in which:

FIG. 1 depicts an axial alignment of an ideal, infinitely long solenoid (or illustrative portion of a finite-length solenoid);

FIG. 2 depicts an axial segment of a solenoid (compared with FIG. 1), using scaled wire dimensions to increase the winding turns per meter;

FIG. 3 depicts a Bitter coil (compared with FIGS. 1 and 2), showing the scaling necessary to increase the winding turns per meter and retaining ampere-turns per meter;

FIG. 4 depicts an armature-stator impact during magneto-cumulative generator firing;

FIG. 5, on coordinates of current (I) and time (T), depicts an ideally square current output across a resistive load as a function of time from a magneto-cumulative generator;

FIG. 6, on coordinates of current (I) and time (T), depicts a flat current output across a resistive load with exponential rise and fall times (time constant r) as a function of time from a magneto-cumulative generator;

FIG. 7 shows a typical embodiment of a conventional coaxial magneto-cumulative generator;

FIG. 8 shows the basic construction strategy of a Bitter coil employed in a magneto-cumulative generator in accordance with the principles of the present invention, showing the current (I) path through the windings and turn-to-turn connections;

FIG. 9 shows a Bitter coil stator replacing solenoidal stator embodiment in a magneto-cumulative generator (compared with FIG. 7);

FIG. 10 shows a segment of a Bitter coil in a magneto-cumulative generator stator where, as an example of this approach, the inner radius of the windings increases turn-by-turn, independent of all other dimensions;

FIG. 11 shows a segment of a Bitter coil in a magneto-cumulative generator stator where, as an example of this approach, the inner radius of the windings remains constant turn-by-turn, independent of all other dimensions;

FIG. 12 shows a segment of a Bitter coil in a magneto-cumulative generator stator where, as an example of this approach, the inner radius of the windings decreases turn-by-turn, independent of all other dimensions;

FIG. 13 shows a segment of a Bitter coil in a magneto-cumulative generator stator where, as an example of this approach, the outer radius of the windings increases turn-by-turn, independent of all other dimensions;

FIG. 14 shows a segment of a Bitter coil in a magneto-cumulative generator stator where, as an example of this approach, the outer radius of the windings remains constant turn-by-turn, independent of all other dimensions;

FIG. 15 shows a segment of a Bitter coil in a magneto-cumulative generator stator where, as an example of this approach, the outer radius of the windings decreases turn-by-turn, independent of all other dimensions;

FIG. 16 shows a segment of a Bitter coil in a magneto-cumulative generator stator where, as an example of this approach, the thickness of the windings increases turn-by-turn, independent of all other dimensions;

FIG. 17 shows a segment of a Bitter coil in a magneto-cumulative generator stator where, as an example of this approach, the thickness of the windings remains constant turn-by-turn, independent of all other dimensions;

FIG. 18 shows a segment of a Bitter coil in a magneto-cumulative generator stator where, as an example of this approach, the thickness of the windings decreases turn-by-turn, independent of all other dimensions;

FIG. 19 shows a segment of a Bitter coil in a magneto-cumulative generator stator where, as an example of this approach, the thickness of the insulation increases turn-to-turn, independent of all other dimensions;

FIG. 20 shows a segment of a Bitter coil in a magneto-cumulative generator stator where, as an example of this approach, the thickness of the insulation remains constant turn-to-turn, independent of all other dimensions;

FIG. 21 shows a segment of a Bitter coil in a magneto-cumulative generator stator where, as an example of this approach, the thickness of the insulation decreases turn-to-turn, independent of all other dimensions;

FIG. 22 shows a segment of a Bitter coil in a magneto-cumulative generator stator where, as an example of this approach incorporating multiple simultaneous changes, the inner and outer radii of the windings progressively increase turn-by-turn to create an increasing “pagoda” structure and modified inductance profile, independent of all other dimensions;

FIG. 23 shows a segment of a Bitter coil in a magneto-cumulative generator stator where, as an example of this approach incorporating multiple simultaneous changes, the inner and outer radii of the windings progressively decrease turn-by-turn to create a decreasing “pagoda” structure and modified inductance profile, independent of all other dimensions;

FIG. 24 shows an example of a Bitter coil stator incorporating multiple simultaneous changes, with constant turn inner and outer radii, but progressively greater turn-by-turn thickness and current capacity, and progressively greater turn-to-turn insulation and high voltage insulating capacity, incorporated into a complete magneto-cumulative generator; and

FIG. 25 shows an example of a Bitter coil stator incorporating multiple simultaneous changes, with constant turn outer radius, but progressively smaller turn-by-turn inner radius and modified inductance profile, greater turn-by-turn thickness and current capacity, and greater turn-to-turn insulation and high voltage insulating capacity, incorporated into a complete magneto-cumulative generator.

### BEST MODES FOR CARRYING OUT THE INVENTION

Classical electrodynamics is governed by Maxwell's equations, written in rationalized (factors of 4π suppressed) Système International (MKSA-meter, kilogram, second, ampere) units as

| | |
|---|---|
| ∇ · D(x,t) = ρ(x,t) | (1) |
| ∇ · B(x,t) = 0 | (2) |
| $∇ \times E ( x , t ) = - \frac{\partial B ( x , t )}{\partial t}$ | (3) |
| $∇ \times H ( x , t ) = \frac{\partial D ( x , t )}{\partial t} + J ( x , t )$ | (4) |

E(x,t) and B(x,t) are respectively the vector (indicated by boldface font) Electric Field and Magnetic Induction (as general functions of vector position x and time t) which are used to calculate forces on charges and currents. D(x,t) and H(x,t) are respectively the vector Electric Displacement and Magnetic Field which are calculational quantities related to E and B in non-vacuum media, and p(x,t) and J(x,t) are respectively the scalar charge density and vector current density. In general, D and H are functions of E and B, i.e., D[E,B] and H[E,B], as is the generalized Ohm's law for J[E,B], where “The square brackets are intended to signify that the connections are not necessarily simple and may depend on past history (hysteresis), may be nonlinear, etc.” (from John David Jackson, Classical Electrodynamics, 2^{nd} Edition, John Wiley & Sons, Inc., New York, 1975, p. 14). For most (but not all) applications in ponderable media the functional dependences for E, B, and J are simplified to linear, homogeneous, and isotropic behavior, giving

$$\begin{matrix}D ( x , t ) = {K}_{e} {ϵ}_{0} E ( x , t ) \\ B ( x , t ) = {K}_{m} {μ}_{0} H ( x , t ) \\ J ( x , t ) = σ E ( x , t )\end{matrix} \} \qquad ( 5 )$$

where εₒ, and μₒ are respectively the (electric) permittivity of free space and (magnetic) permeability of free space, Kₑ and Kₘ are respectively the relative permittivity (also called the dielectric coefficient or dielectric constant) and relative permeability of the medium in question, and σ is the conductivity. In vacuum, Kₑ=Kₘ=1 (dimensionless).

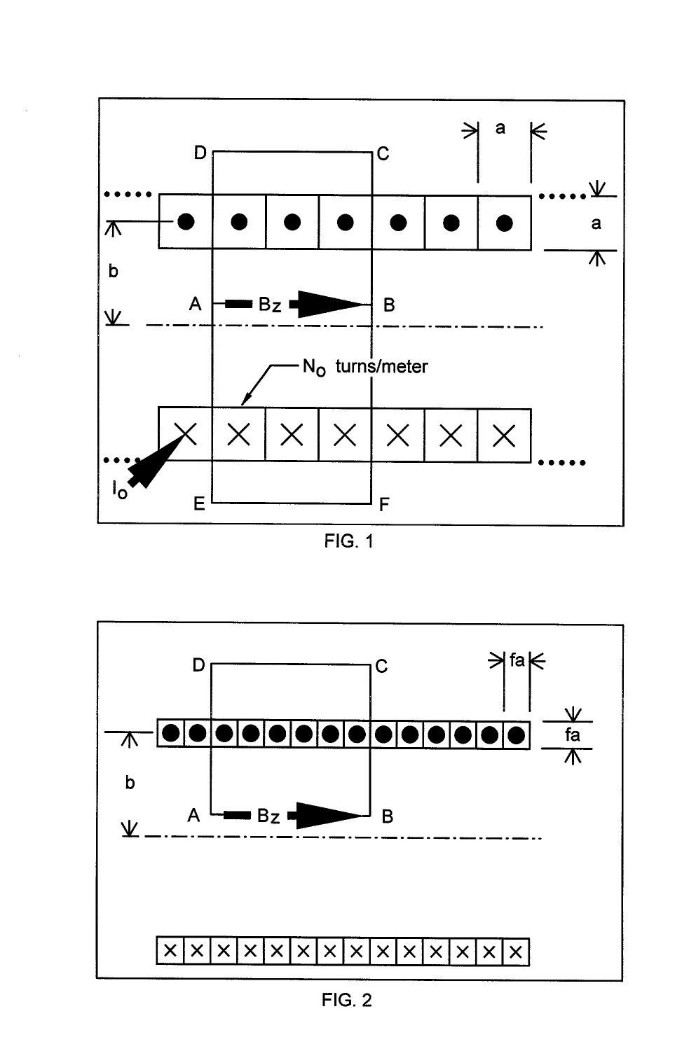

Magnetostatic phenomena are governed by Equations 2 and 4 with time derivatives identically zero (or negligibly small, where all quantities change very slowly with time). In FIG. 1, we first consider an axial portion of an infinitely long ideal solenoid where the ratio of wire diameter to winding diameter is negligibly small; there is no pitch error, i.e., only azimuthal components to J. The solenoid has an arbitrary mean winding radius b meters, Nₒ winding turns per meter, and carries Iₒ amperes of current per turn. (The direction of positive current flow is indicated by “●” out of the plane of the paper, and “x” into the plane of the paper.) Applying Equation 4 around the paths ABCD versus EFCD and invoking symmetry arguments, it is determined B=0 outside the solenoid, but a perfectly uniform B inside the solenoid exists parallel to the solenoid axis, with magnitude independent of radial or axial location, of the value

B(x,t)=μₒIₒNₒe_{z} (6)

where e_{z} is the axial unit vector in the cylindrical (r,Φ,z) coordinate system.

The product IₒNₒ is the ampere-turns per meter of the solenoid, which determines the magnitude of the Magnetic Induction inside the solenoid. Thus a perfectly uniform B of arbitrarily high magnitude is theoretically possible under these ideal conditions. In practice, a solenoid of finite length A and small winding pitch error can be made to produce B with arbitrarily small spatial inhomogeneities within an arbitrarily large interior volume at the solenoid's equator by making the solenoid's aspect ratio Λ/b sufficiently large.

We now discuss some advantages of the Bitter coil that are organic to its use within a magneto-cumulative generator. Now consider FIG. 1 to represent a segment of a finite-length solenoid wound with square wire of dimensions a meters on a side. We calculate the turns per meter of winding

Nₒ=turns/meter=1/a (7)

and the resistance per meter of winding

$${R}_{0} = \frac{1}{σ} ( \frac{1}{{a}^{2}} ) ( 2 π {bN}_{0} ) = \frac{1}{σ} 2 π \frac{b}{{a}^{3}} \qquad ( 8 )$$

where σ is the conductivity. If we put Vₒ volts across 1 meter of winding, then by Ohm's law we can calculate the current as Iₒ=Vₒ/Rₒ. Then the ampere-turns per meter is

$${I}_{0} {N}_{0} = \frac{{V}_{0} {a}^{3} σ}{2 π b} ( \frac{1}{a} ) = \frac{{V}_{0} {a}^{2} σ}{2 π b} \qquad ( 9 )$$

If we re-perform this calculation as per FIG. 2, for the same mean winding radius but wire scaled in cross section by a factor f<1, the turns per meter becomes

N′=1/fa>Nₒ (10)

but the ampere-turns per meter becomes

I′N′=f²IₒNₒ<IₒNₒ (11)

We conclude for real conductors that simply using smaller sized wire to get high turns per meter (higher inductance, as the square of the total number of turns) actually reduces the ampere-turns per meter (hence the magnitude of internal B) for the same applied voltage.

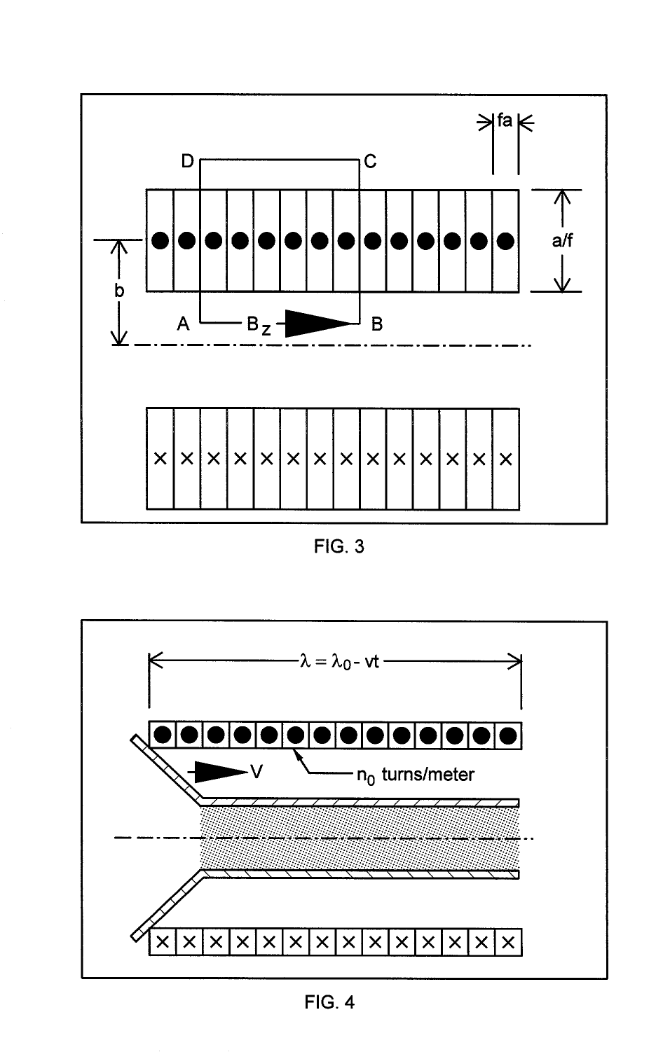

We now consider FIG. 3, where the axial thickness of the winding is reduced by the same factor f<1, but the annular width of the winding is increased by the same factor. This configuration represents a Bitter coil. Then the turns per meter becomes

N″=1/fa<Nₒ (12)

as before, but the ampere-turns per meter reverts to

I″N″=IₒNₒ (13)

also as before.

We conclude the Bitter coil permits both qualities of higher turns per meter (and higher inductance) while preserving the ampere-turns per meter (magnitude of internal B) for the same applied voltage. In the context of magneto-cumulative generators the first quality translates into a larger ratio of inductance change (hence amplification of electrical energy) as the armature-stator contact point moves downstream. The second quality enables a higher initial magnetic energy to be created (determined by |B|²), which when combined with the larger ratio of inductance change means an inherently greater final energy yield for the magneto-cumulative generator.

It should be obvious that reducing the axial thickness of the winding by f but increasing the annular width of the winding by greater than f increases both the overall inductance and the ampere-turns per meter (magnitude of internal B) for the same applied voltage. Thus we conclude that even if no other change is made, the use of a conventional Bitter coil as a stator of a magneto-cumulative generator necessitates a significant improvement in the energy output of such devices.

It might be challenged that this simple substitution of a Bitter coil for a simple solenoid in a magneto-cumulative generator should be obvious to “a person having ordinary skill in the art to which said subject matter pertains” and hence, not patentable. There is no indication in the open technical literature that this design change in magneto-cumulative generators has ever been entertained, despite the performance improvements discussed above.

Research into the design of magneto-cumulative generators has been openly discussed in the technical community since 1965 (H. Knoepfel and F. Herlach, editors, Conference on Megagauss Magnetic Field Generation by Explosives and Related Experiments, proceedings of a symposium held in Frascati, Italy, September 21-23, 1965). The first paper in those proceedings (C. M. Fowler et al., “The Los Alamos Flux Compression Program from its Origin”, p.1 op. cit.) states that the Los Alamos program in this field “began in late 1957” and alludes to embryonic classified research activity in this field prior to 1944. As far as can be determined, the use of a Bitter coil stator in any form has never been suggested, let alone implemented and tested, in the design of magneto-cumulative generators in the intervening 50 years.

Despite the seemingly obvious performance improvements to be obtained, recent magneto-cumulative generator designs still display no Bitter coil stators. This contention is corroborated when examining the aforementioned book Magnetocumulative Generator edited by Altgilbers et al., wherein a stator design using Bitter coils is never mentioned. This strongly suggests even the simple substitution of an ordinary solenoidal stator with an equally ordinary Bitter coil stator (constant dimensions for the inner and outer radii, winding thickness, and inter-winding insulation) is not readily within the purview of “a person having ordinary skill in the art to which said subject matter pertains”.

As will be discussed immediately below, using a non-standard Bitter coil-type design approach for a magneto-cumulative generator permits even further improvement beyond even total energy yield in the output of magneto-cumulative generators. A turn-by-turn modification of four Bitter coil design parameters (inner radius, outer radius, individual turn thickness, and turn-to-turn insulation thickness as functions of position along the longitudinal axis) can provide a design approach to compensate for performance deficiencies revealed in real magneto-cumulative generator experiments.

A highly idealized magneto-cumulative generator can be modeled with a seemingly simple circuit equation

$$\frac{ⅆ}{ⅆ t} [ L ( t ) I ( t ) ] + RI ( t ) = 0 \qquad ( 14 )$$

where L(t) is the total self-inductance of the stator as a function of time, I(t) is the instantaneous current flowing through the circuit as a function of time, and R is the load resistance, ideally considered to be constant in time. These idealizations ignore actual physical phenomena within the magneto-cumulative generator. For example, while L(t) is normally a purely geometric factor, magnetic flux losses of various origins de facto reduces the linking flux between elements of the stator, hence effectively reduces L(t). The load resistance R may or may not be constant in time, and does not include added resistance in the stator as the stator windings heat up. These real world effects are incorporated in the sophisticated computer codes (e.g., CAGEN) used to model magneto-cumulative generators.

Even with a simple solenoidal stator, Equation 14 becomes very complicated. Regarding FIG. 4, we see a magneto-cumulative generator just after the initiation of the high explosive within the armature, and at the time of first electrical contact of the armature with the stator. The explosively deformed armature travels to the right with velocity v. At this point in time (=0 for convenience) the remaining length of the stator λ(t) can be written

λ(t)=λₒ−vt (15)

where λₒ is the original length at t=0. If the solenoid has no turns per meter, then the remaining total turns at time t is

n(t)=nₒλ(t) (16)

and the stator inductance L(t) is approximately a geometric factor k times the remaining total turns squared:

L(t)=k[n(t)]²kn²ₒ(λ₀−vt)² (17)

Performing the differentiation and substituting into Equation 14:

$${{kn}_{0}^{2} ( {λ}_{0} - vt )}^{2} \frac{ⅆ I ( t )}{ⅆ t} + [ R - 2 {vkn}_{0}^{2} ( {λ}_{0} - vt ) ] I ( t ) = 0 \qquad ( 18 )$$

The coefficients of this differential equation are themselves functions of time, making the solution difficult. At the present state of the art of magneto-cumulative generator design, whatever time profile and energy amplification that emerges from Equation 18, modified by non-idealized factors being realized, must be conditioned into a usable form with transformers, fuses, and pulse-shaping electrical components. As these components require added volume and weight, to the extent they can be eliminated enhances the potential utility of magneto-cumulative generators.

To use a tailored magneto-cumulative generator output using a modified Bitter coil stator, the following methodology is proposed: Determine a priori the current versus time profile of the desired output, consistent with general constraints of magneto-cumulative generator outputs. From the desired current profile, determine from modeling equations or computer simulation the inductance versus time profile to achieve the desired current profile. An electromagnetic design code can then be used to build up the desired inductance from the last, most downstream turn backwards to the first, most upstream turn. As a practical matter, a library of pre-calculated Bitter coil structures may be assembled to make a first estimate of the inductance versus time profiles to be obtained from simple structures.

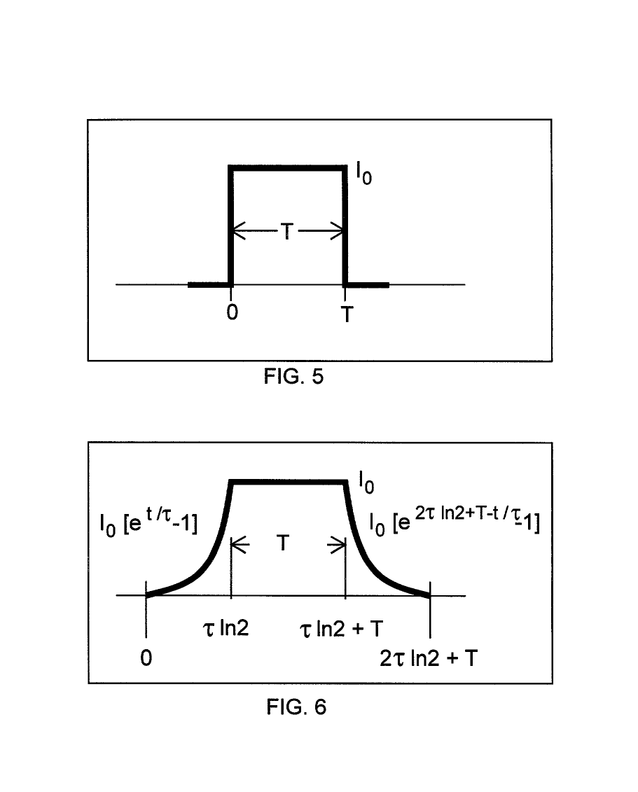

For example, assume the ideally square current waveform shown in FIG. 5 across the load R is desired. Using the Heavyside step function Θ(x) (=0 for x<0,=½ for x=0, or=1 for x>0) and the fact dΘ/dx=δ(x) (the Dirac delta function), the desired output current is

$$\begin{matrix}I ( t ) = {I}_{0} Θ ( t ) Θ ( T - t ) \\ \frac{ⅆ I}{ⅆ t} = {I}_{0} δ ( t ) Θ ( T - t ) - {I}_{0} Θ ( t ) δ ( T - t )\end{matrix} \} \qquad ( 19 )$$

and Equation 14 becomes a differential equation for L

$$\begin{matrix}\frac{ⅆ L}{ⅆ t} {I}_{0} Θ ( t ) Θ ( T - t ) + L ( {I}_{0} δ ( t ) Θ ( T - t ) - {I}_{0} Θ ( t ) δ ( T - t ) ] + \\ {RI}_{0} Θ ( t ) Θ ( T - t ) = 0\end{matrix} \} \qquad ( 20 )$$

Using the properties of the Θ-and δfunctions, during the pulse

$$\begin{matrix}\frac{ⅆ L}{ⅆ t} {I}_{0} + {RI}_{0} = 0 \\ L ( t ) = - Rt + constant\end{matrix} \} \qquad ( 21 )$$

At the t=0 inflection point

$$\begin{matrix}\frac{ⅆ L}{ⅆ t} \underbrace{Θ ( 0 )}_{= 1 / 2} + L ( 0 ) δ ( 0 ) + R \underbrace{Θ ( 0 )}_{= 1 / 2} = 0 \\ \frac{ⅆ L}{ⅆ t} + 2 L ( 0 ) δ ( 0 ) + R = 0 \\ L ( {0}^{+} ) - L ( {0}^{-} ) = \underbrace{- R ( {0}^{+} - {0}^{-} )}_{= 0} - 2 L ( 0 )\end{matrix} \} \qquad ( 22 )$$

while at the t=T inflection point

$$\begin{matrix}\frac{ⅆ L}{ⅆ t} \underbrace{Θ ( 0 )}_{= 1 / 2} - L ( T ) δ ( T - t ) + R \underbrace{Θ ( 0 )}_{= 1 / 2} = 0 \\ \frac{ⅆ L}{ⅆ t} - 2 L ( T ) δ ( T - t ) + R = 0 \\ L ( {T}^{+} ) - L ( {T}^{-} ) = \underbrace{- R ( {T}^{+} - {T}^{-} )}_{= 0} - 2 L ( T )\end{matrix} \} \qquad ( 23 )$$

Equation 21 shows L must have a negative linear time dependence to obtain a flat pulse, whereas Equation 18 shows that for a normal solenoidal winding L has a dependence as time-squared. Equations 22 and 23 show that at the two inflection points the functional values of the remaining L must jump down or up by the prescribed value to obtain a perfectly square pulse. The fact L must have a specific linear (not quadratic) time profile, must change discontinuously, and with both positive and negative algebraic signs, also argues the utility of Bitter coils for use in magneto-cumulative generators. This is because inductance is a geometric property linking the magnetic flux created by one turn of the coil with the remaining turns. Only through the use of a Bitter coil-type winding proposed in this patent can the relative geometry between turns be changed on a turn-by-turn basis while simultaneously solving the problems of conducting high current through the windings and insulating high voltage between the windings, especially at the last few downstream windings.

For current profiles with finite rise and fall times, the above procedure can be repeated for whatever mathematical functional rise and fall time is appropriate, and the solutions to L can be piecewise matched. For example, assume a flat current with exponential rise and fall as shown in FIG. 6 across the load R is desired. Then the desired output current is

$$\begin{matrix}\begin{matrix}I ( t ) = Θ ( t ) {I}_{0} [ {ⅇ}^{t / τ} - 1 ] Θ ( τ ln 2 - t ) + \\ Θ ( t - τ ln 2 ) {I}_{0} Θ [ ( τ ln 2 + T ) - t ] + \\ Θ [ t - ( τ ln 2 + T ) ] {I}_{0} [ {ⅇ}^{( 2 τ ln 2 + T - t ) / τ} - 1 ] Θ [ ( 2 τ ln 2 + T ) - t ]\end{matrix}\end{matrix} \} \qquad ( 24 )$$

Factoring out the common Iₒ, the time derivative of Equation 24 is

$$\begin{matrix}\begin{matrix}\frac{1}{{I}_{0}} \frac{ⅆ I ( t )}{ⅆ t} = \underbrace{δ ( t ) [ {ⅇ}^{t / τ} - 1 ] Θ ( τ ln 2 - t )}_{( 1 )} + \\ \underbrace{Θ ( t ) \frac{1}{τ} [ {ⅇ}^{t / τ} ] Θ ( τ ln 2 - t )}_{( 2 )} - \\ \underbrace{Θ ( t ) [ {ⅇ}^{t / τ} - 1 ] δ ( t - τ ln 2 )}_{( 3 )} + \\ \underbrace{δ ( t - τ ln 2 ) δ [ ( τ ln 2 + T ) - t ]}_{( 4 )} - \\ \underbrace{Θ ( t - τ ln 2 ) δ [ t - ( τ ln 2 + T ) ]}_{( 5 )} + \\ \underbrace{δ [ t - ( τ ln 2 + T ) ] [ {ⅇ}^{( 2 τ ln 2 + T - t ) / τ} - 1 ] Θ [ ( 2 τ ln 2 + T ) - t ]}_{( 6 )} - \\ \underbrace{Θ [ t - ( τ ln 2 + T ) ] \frac{1}{τ} [ {ⅇ}^{( 2 τ ln 2 + T - t ) / τ} ] Θ [ ( 2 τ ln 2 + T ) - t ]}_{( 7 )} - \\ \underbrace{Θ [ t - ( τ ln 2 + T ) ] [ {ⅇ}^{( 2 τ ln 2 + T - t ) τ} - 1 ] δ [ t - ( 2 τ ln 2 + T ) ]}_{( 8 )}\end{matrix}\end{matrix} \} \qquad ( 25 )$$

Again using the properties of the Θ- and δ-functions in Equation 25, the various eight terms become

$$\begin{matrix}\begin{matrix}= \underbrace{δ ( t ) \overbrace{[ {ⅇ}^{0 / τ} - 1 ]}^{= 0} \overbrace{Θ ( τ ln 2 )}^{= 1}}_{( 1 ) = 0} + \\ \underbrace{Θ ( t ) \frac{1}{τ} [ {ⅇ}^{t / τ} ] Θ ( τ ln 2 - t )}_{( 2 )} - \\ \underbrace{\overbrace{Θ ( τ ln 2 )}^{= 1} \overbrace{[ {ⅇ}^{τ ln 2 / τ} - 1 ]}^{= 1} δ ( t - τ ln 2 )}_{( 3 )} + \\ \underbrace{δ ( t - τ ln 2 ) \overbrace{Θ [ τ ln 2 + T - τ ln 2 ]}^{= 1}}_{( 4 )} - \\ \underbrace{\overbrace{Θ ( τ ln 2 + T - τ ln 2 )}^{= 1} δ [ t - ( τ ln 2 + T ) ]}_{( 5 )} + \\ \underbrace{δ [ t - ( τ ln 2 + T ) ] \overbrace{[ {ⅇ}^{( 2 τ ln 2 + T - τ ln 2 - T ) / τ} - 1 ]}^{= 1} \overbrace{Θ [ 2 τ ln 2 + T - τ ln 2 - T ]}^{= 1}}_{( 6 )} - \\ \underbrace{Θ [ t - ( τ ln 2 + T ) ] \frac{1}{τ} [ {ⅇ}^{( 2 τ ln 2 + T - t ) / τ} ] Θ [ ( 2 τ ln 2 + T ) - t ]}_{( 7 )} - \\ \underbrace{\overbrace{Θ [ 2 τ ln 2 + T - τ ln 2 - T ]}^{= 1} \overbrace{[ {ⅇ}^{( 2 τ ln 2 + T - 2 τ ln 2 - T ) / τ} - 1 ]}^{= 0} δ [ t - ( 2 τ ln 2 + T ) ]}_{( 8 )}\end{matrix}\end{matrix} \} \qquad ( 26 )$$

and only two terms, (2) and (7), survive. Equation 14 becomes a differential equation for L

$$\begin{matrix}\begin{matrix}{I}_{0} \frac{ⅆ L}{ⅆ t} \{ Θ ( t ) [ {ⅇ}^{t / τ} - 1 ] Θ ( τ ln 2 - t ) + \\ Θ ( t - τ ln 2 ) Θ [ ( τ ln 2 + T ) - t ] + \\ Θ [ t - ( τ ln 2 + T ) ] [ {ⅇ}^{( 2 τ ln 2 + T - t ) / τ} - 1 ] Θ [ ( 2 τ ln 2 + T ) - t ] \} + \\ {I}_{0} L \{ Θ ( t ) \frac{1}{τ} [ {ⅇ}^{t / τ} ] Θ ( τ ln 2 - t ) - \\ Θ [ t - ( τ ln 2 + T ) ] \frac{1}{τ} [ {ⅇ}^{( 2 τ ln 2 + T - t ) / τ} ] Θ [ ( 2 τ ln 2 + T ) - t ] \} + \\ {I}_{0} R \{ Θ ( t ) [ {ⅇ}^{t / τ} - 1 ] Θ ( τ ln 2 - t ) + \\ Θ ( t - τ ln 2 ) Θ [ ( τ ln 2 + T ) - t ] + \\ Θ [ t - ( τ ln 2 + T ) ] [ {ⅇ}^{( 2 τ ln 2 + T - t ) / τ} - 1 ] Θ [ ( 2 τ ln 2 + T ) - t ] \} = 0\end{matrix}\end{matrix} \} \qquad ( 27 )$$

The Θ-functions represent three contiguous time periods, the pulse's rise, plateau, and fall

$$\begin{matrix}\begin{matrix}\{ \frac{ⅆ L}{ⅆ t} + \frac{1}{τ} [ \frac{1}{1 - {e}^{- t / τ}} ] L + R \} Θ ( t ) Θ ( τ ln 2 - t ) = 0 \\ \{ \frac{ⅆ L}{ⅆ t} + R \} Θ ( t - τln 2 ) Θ [ ( τ ln 2 + T ) - t ] = 0 \\ \{ \frac{ⅆ L}{ⅆ t} - \frac{1}{τ} [ \frac{1}{1 - \frac{1}{4} {ⅇ}^{( t - T ) / τ}} ] L + R \} Θ [ t - ( τ ln 2 + T ) ] Θ [ ( 2 τln 2 + T ) - t ] = 0\end{matrix}\end{matrix} \} \qquad ( 28 )$$

Equations 28 can be satisfied if the three equations contained in {} are themselves equal to zero. Then the various L(t) functions in the three time periods must be matched in value at the t=(τ ln2) and (τ r ln2+T) inflection points.

There are four distinct Bitter coil dimensional parameters that can change turn-by-turn: inner radius, outer radius, winding thickness, and insulation thickness. The immediately-downstream component can increase, stay the same, or decrease in value from the previous component. Thus there are 3⁴=81 possible dimensional permutations to the next downstream turn, plus the practical matter that the insulation material itself can also change from turn-to-turn if desired.

Referring again to the drawing figures, FIG. 7 shows an embodiment of a conventional coaxial magneto-cumulative generator 10. The basic technical approach of the conventional magneto-cumulative generator 10 is to use a comparatively small “seed” current (on the order of a kiloampere) to establish an initial magnetic field within a confined, hollow metallic enclosure (formed by an armature 11 and stator 15). An explosive charge (high explosive 13) is then initiated by an initiator 14 to expand and crush a conducting metal liner 12 against the stator 15. The enclosed magnetic field can be likened to a gas that exerts pressure against the collapsing metal walls. As such, there is work done by the explosive 13 against the magnetic field which is analogous to a thermodynamic “P dV” work against a gas. The added energy from this work manifests itself as increased current flow through the magneto-cumulative generator 10 (as opposed to increased temperature of the gas). Final currents on the order of megamperes have been reported by researchers. Magneto-cumulative generators 10 are inherently one-shot devices.

More specifically, the conventional coaxial magneto-cumulative generator comprises a coaxial alignment of the armature 11 which is comprised of the conducting metal liner 12 filled with the high explosive 13 and which is initiated by the initiator 14 from the axial center of one end of the high explosive 13. Coaxially aligned with and surrounding the armature 11 is a stator 15, which is typically a single-layer, solenoidal-type winding of heavy-gauge copper wire and high-voltage insulation. The windings of the stator 15 can be supported by an exterior coaxial mandrel (not shown).

To engage the magneto-cumulative generator 10, a “seed” capacitor 16 is charged, then discharged by a switch 17 into the stator 15. The return current from this discharge flows through a load 18, then through the armature 11 back to the seed capacitor 16. Typically, the load 18 has a very low resistance to permit the maximum magnitude of current to develop. The load 18 may in fact be a complicated electrical structure, involving additional switches, transformers, capacitors, inductors, and the like, to aid in forming and conditioning the output waveform of the magneto-cumulative generator 10. This current flow establishes a magnetic field in the annular region exterior to the armature 11 and interior to the stator 15. The current flow maximizes at a time which depends primarily on the values of the seed capacitor 16, the inductance of the windings of the stator 15, and the total impedance (resistance, and inductive and capacitive reactance) of the load 18. As the maximum current value is reached, the high explosive 13 is initiated.

Upon initiation, a detonation front 19 in the high explosive 13 deforms the armature 11 until it makes conductive contact with first turn of the stator 15. The seed capacitor 16 is then shorted out. As the detonation front moves axially down the armature 11, the contact point between the armature 1 1 and the stator 15 also moves correspondingly. This motion progressively lowers the inductance of the stator 15. As shown in the prior discussion, the time derivative of the inductance value (dL/dt) of the stator 15 is an important parameter to control and optimize in the design of the magneto-cumulative generator 10.

The prior discussion is idealized, and the process of designing a practical magneto-cumulative generator requires attention to the behavior of non-ideal components. Some design and fabrication practices that are normally observed are the following.

The armature 11 should be made of seamless copper tubing, with the alloy and manufacturing certifications recorded and monitored. Not only is copper an excellent conductor, it is highly ductile under explosive deformation and maintains an uninterrupted conducting current path. Heat treatment of copper can make it even softer. The use of aluminum as the armature 11 is discouraged, as it becomes brittle and can shatter under explosive action. Shattering can lead to magnetic flux losses.

To ensure homogeneity of the explosive 13, pressing a flake-like explosive 13 such as LX-14 into a solid piece is recommended. Hand-packing C-4 explosive 13 could lead to boundaries, voids, and density variations. Cast explosives 13 such as Composition-B or Octol can exhibit density segregation from their pouring and cooling, even if the cool-down is controlled to avoid cracking in the explosive grain. LX-14 explosive 13 also has an inherently faster detonation velocity of about 20 percent greater than the other cited explosives 13.

Voids and cracks along the wall of the armature 11 and explosive interface can lead to “jetting” of hot gas along the length of the explosive grain at a greater velocity than the detonation velocity, which could lead to asymmetric initiation. To avoid jetting, a slightly oversized LX-14 form is pressed, and is then precision-machined to produce an interference fit with the armature 11. The armature 11 is also precision-machined, then heated moderately while the explosive 13 is cooled to obtain a hot/cold thermal shrink fit.

The possibilities of radially asymmetric initiation of the high explosive 13 can be minimized by using a precision initiation coupler to center the detonation wave precisely between the initiator 14 and the explosive 13.

Conventional magneto-cumulative generators 10 suffer from technical impediments. A representative but incomplete listing derived from researchers includes magnetic flux losses that lower efficiency. Flux may be lost through diffusion of the magnetic field through good but not perfect conductors, a shattered armature 11, insulation between stator windings and “clocking” of the conductive contact point between the expanding armature 11 and the stator 15, wherein the contact point follows the pitch of the windings of the stator 15, but leaves a continuous opening through which flux can escape.

Other technical impediments include progressively greater current loading of the windings of the stator 15 as the stator length effectively shortens, progressively greater turn-to-turn voltage across the windings of the stator 15 as the length of the stator 15 effectively shortens, a possible need to tailor the inductance per unit length of the stator 15 into a profile to obtain a modicum of pulse shaping, and a possible need to vary the pitch of the windings of the stator 15 per unit length of the stator into a profile to obtain a modicum of pulse shaping.

In order to overcome the limitations discussed above with regard to conventional coaxial magneto-cumulative generators 10 an improved magneto-cumulative generator 30 is provided by the present invention, which will be described with reference to FIGS. 8-25.

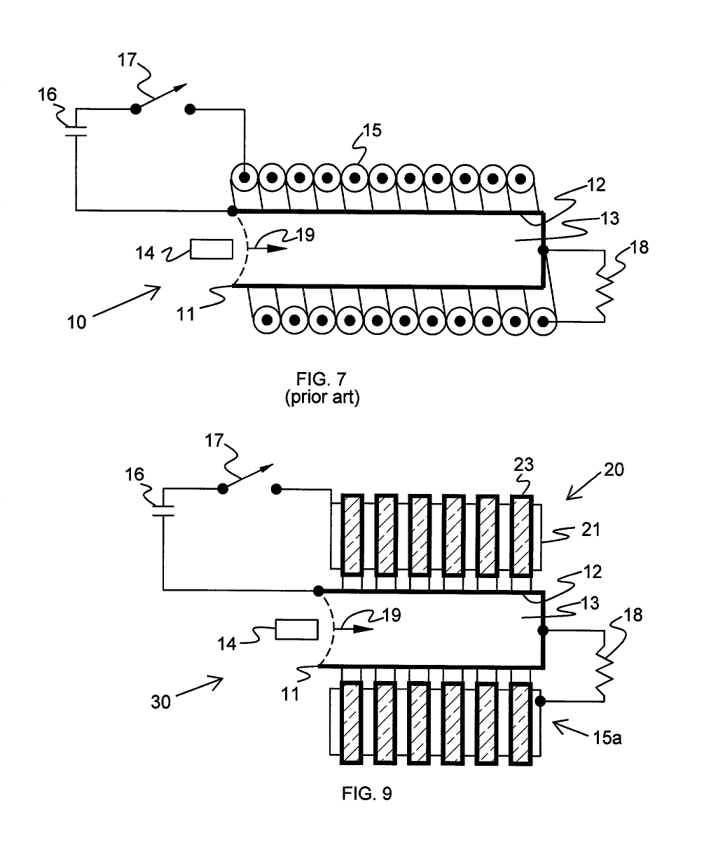

FIG. 8 shows the basic construction of a Bitter coil 20 employed in the improved magneto-cumulative generator 30 of the present invention. The Bitter coil 20 comprises a plurality of disk-like windings 21 interconnected by turn-to-turn connecting elements 22. FIG. 8 shows the current path (I), illustrated by the dashed line with arrowheads, through the windings 21 and turn-to-turn connecting elements 22. In FIG. 8, the amount of separation between the windings 21 is exaggerated for clarity, and is filled with insulation 23 (shown in FIGS. 9-25). This type of Bitter coil 20 is used in the present magneto-cumulative generator 30 and different embodiments thereof will be discussed with reference to FIGS. 9-25. In addition, the angular sector removed from each winding is exaggerated at 90°, when in reality the removed angular sector is a much smaller angle.

The present magneto-cumulative generator 30 uses Bitter coil-type electromagnet windings 21 to address the category of impediments discussed above. Bitter coils 20 are a series of conducting annular disks (windings 21) with an azimuthal sector of the conducting annular disk removed. The disks are stacked with interleaved insulation 23, and overtly connected turn-by-turn at the slots. It can be seen in FIG. 8 that the slots and connecting pieces progressively rotate their azimuthal positions along the axis of the coil.

Referring to FIG. 9, it shows a basic magneto-cumulative generator 30 employing the Bitter coil 20 shown in FIG. 8. The magneto-cumulative generator 30 comprises an armature 11 having a conducting metal liner 12 filled with the high explosive 13 that is initiated by the initiator 14 from one end of the high explosive 13. Coaxially aligned with and surrounding the armature 11 is a stator 1 Sa, which comprises the Bitter coil 20 shown in FIG. 8. A seed capacitor 16 coupled by way of a switch 17 into the Bitter coil 20 of the stator 15a. A load 18 is coupled between the armature 11 and the Bitter coil 20.

To engage the magneto-cumulative generator 30, the seed capacitor 16 is charged, then discharged by the switch 17 into the stator 15a. The return current from this discharge flows through the load 18, then through the armature 11 back to the seed capacitor 16. This current flow establishes a magnetic field in the Bitter coil 20 exterior to the armature 11 and interior to the stator 1 Sa. The current flow maximizes over time, and when the maximum current value is reached, the high explosive 13 is initiated. The magneto-cumulative generator 30 shown in FIG. 9 has windings 21 with a constant size and the thickness of the insulation 23 between windings 21 is constant.

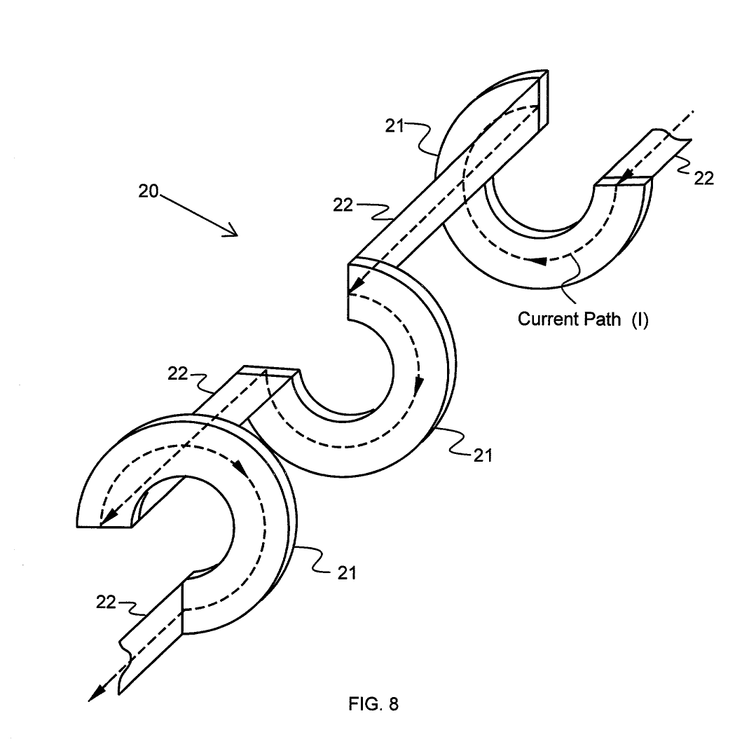

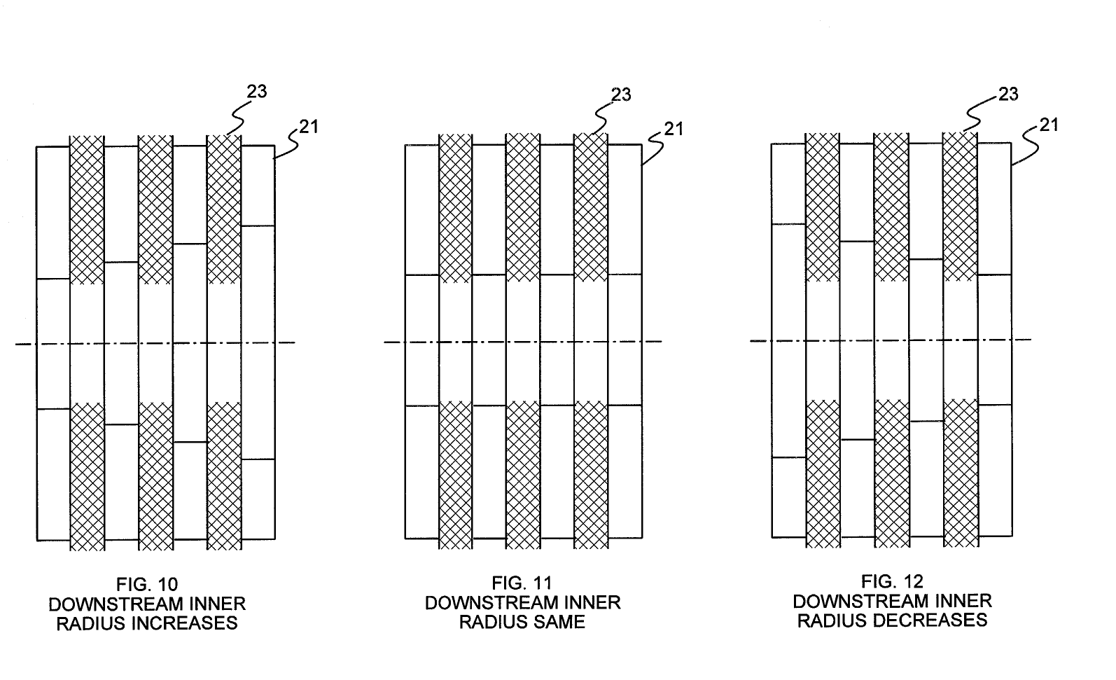

FIG. 10 shows a magneto-cumulative generator 30 wherein the windings 21 of the Bitter coil 20 have the inner radii of the windings increase turn-by-turn, independent of all other dimensions, progressively along the length of the Bitter coil 20.

FIG. 11 shows a magneto-cumulative generator 30 wherein the windings 21 of the Bitter coil 20 have the inner radii of the windings remain constant turn-by-turn, independent of all other dimensions, progressively along the length of the Bitter coil 20.

FIG. 12 shows a magneto-cumulative generator 30 wherein the windings 21 of the Bitter coil 20 have the inner radii of the windings decrease turn-by-turn, independent of all other dimensions, progressively along the length of the Bitter coil 20.

FIG. 13 shows a magneto-cumulative generator 30 wherein the windings 21 of the Bitter coil 20 have the outer radii of the windings increase turn-by-turn, independent of all other dimensions, progressively along the length of the Bitter coil 20.

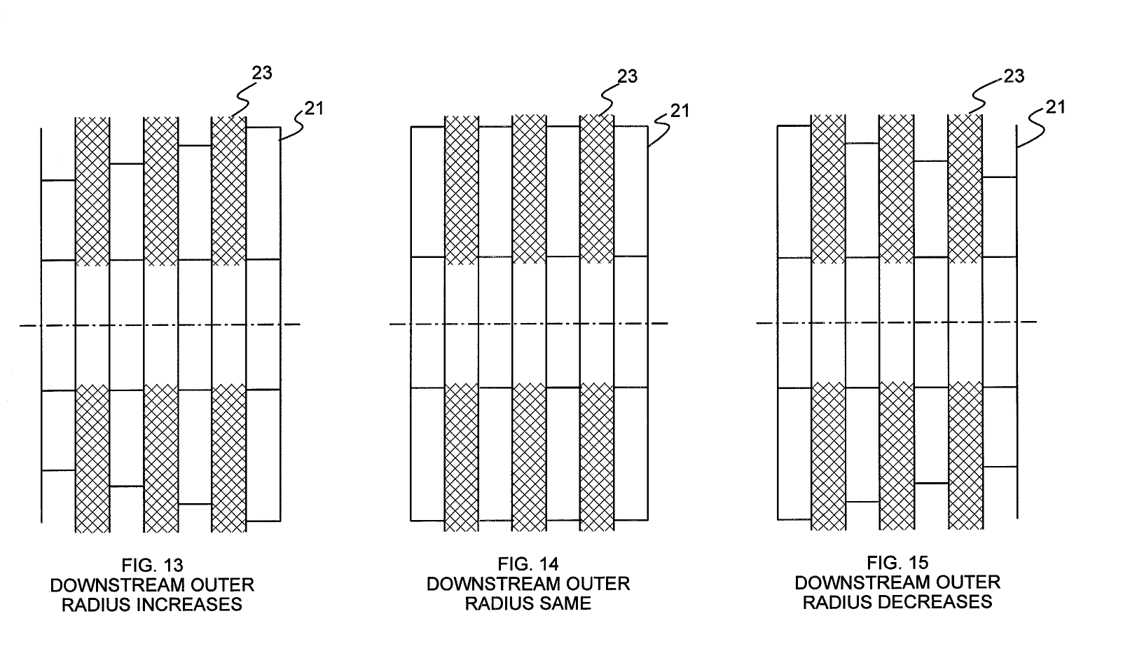

FIG. 14 shows a magneto-cumulative generator 30 wherein the windings 21 of the Bitter coil 20 have the outer radii of the windings remain constant turn-by-turn, independent of all other dimensions, progressively along the length of the Bitter coil 20.

FIG. 15 shows a magneto-cumulative generator 30 wherein the windings 21 of the Bitter coil 20 have the outer radii of the windings decrease turn-by-turn, independent of all other dimensions, progressively along the length of the Bitter coil 20.

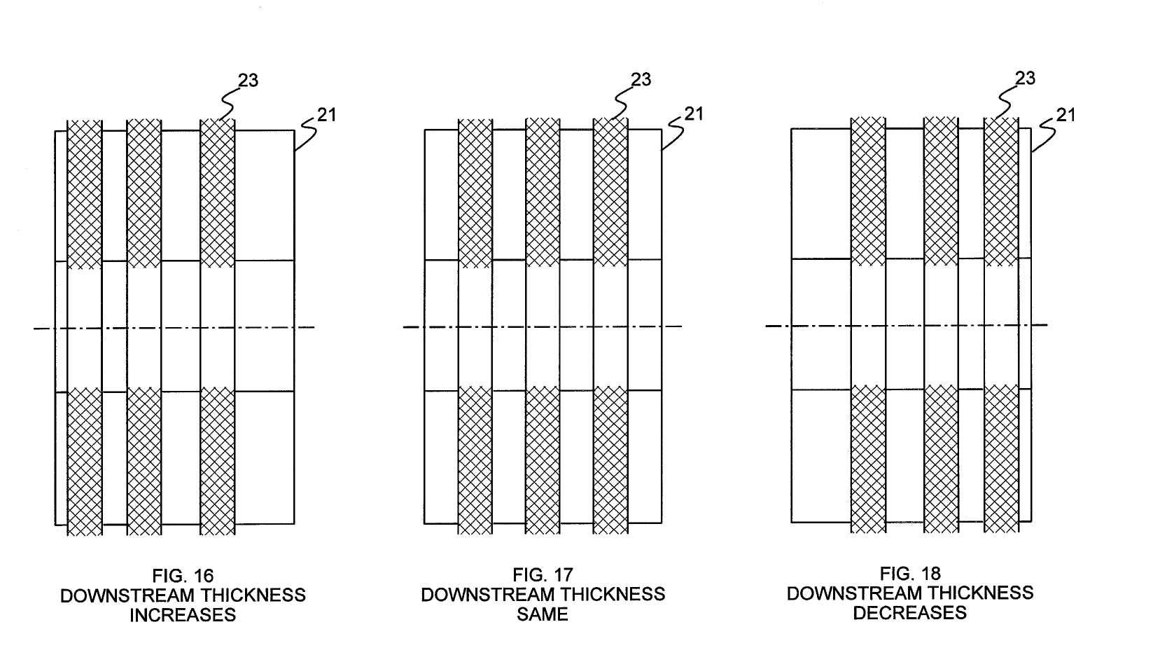

FIG. 16 shows a magneto-cumulative generator 30 wherein the windings 21 of the Bitter coil 20 have the thickness of the windings increase turn-by-turn, independent of all other dimensions, progressively along the length of the Bitter coil 20.

FIG. 17 shows a magneto-cumulative generator 30 wherein the windings 21 of the Bitter coil 20 have the thickness of the windings remain constant turn-by-turn, independent of all other dimensions, progressively along the length of the Bitter coil 20.

FIG. 18 shows a magneto-cumulative generator 30 wherein the windings 21 of the Bitter coil 20 have the thickness of the windings decrease turn-by-turn, independent of all other dimensions, progressively along the length of the Bitter coil 20.

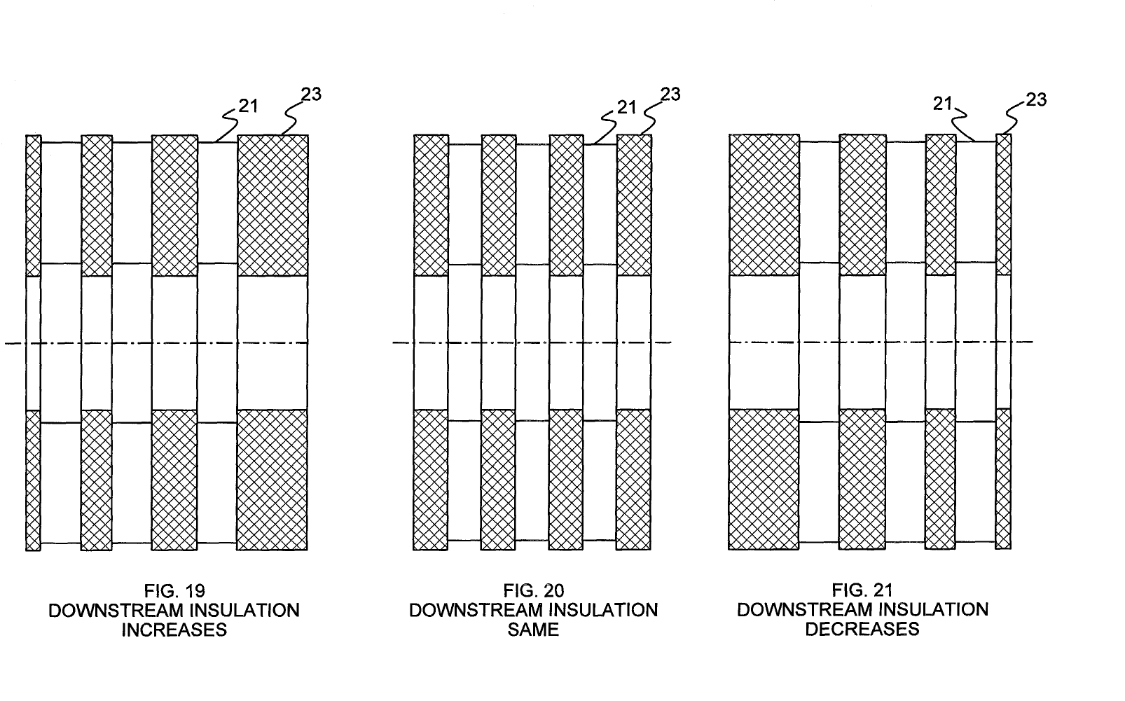

FIG. 19 shows a magneto-cumulative generator 30 wherein the windings 21 of the Bitter coil 20 have the thickness of the insulation 23 increase turn-to-turn, independent of all other dimensions, progressively along the length of the Bitter coil 20.

FIG. 20 shows a magneto-cumulative generator 30 wherein the windings 21 of the Bitter coil 20 have the thickness of the insulation 23 remain constant turn-to-turn, independent of all other dimensions, progressively along the length of the Bitter coil 20.

FIG. 21 shows a magneto-cumulative generator 30 wherein the windings 21 of the Bitter coil 20 have the thickness of the insulation 23 decrease turn-to-turn, independent of all other dimensions, progressively along the length of the Bitter coil 20.

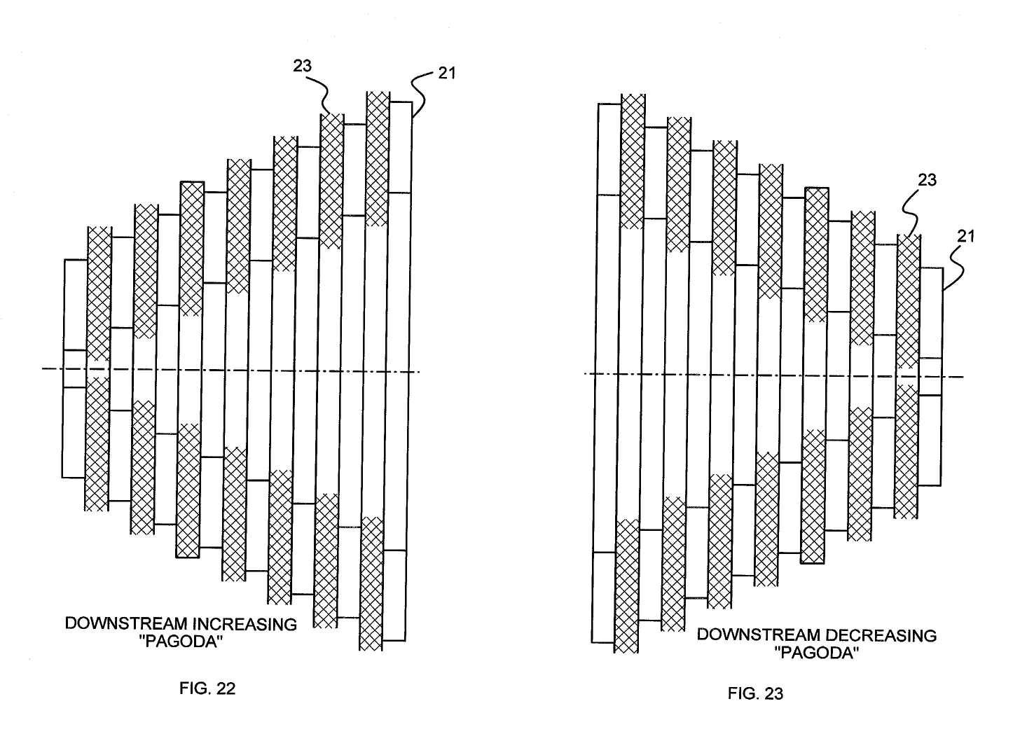

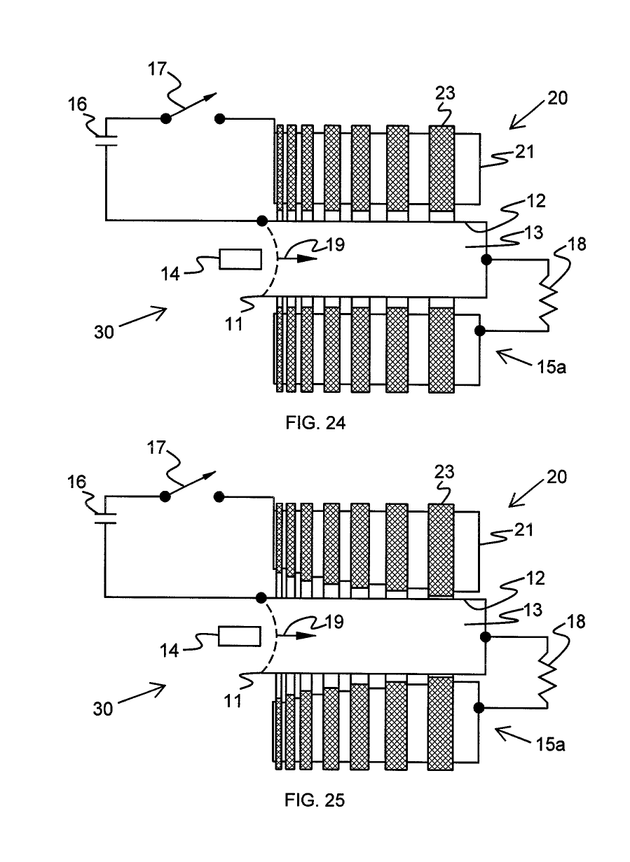

FIGS. 10-21 represent basic single changes for each of the four principal dimensions (turn inner radius, turn outer radius, turn thickness, and turn-to-turn insulation thickness) relevant to the constituent components of a Bitter coil design. FIGS. 22-25 represent just four of many possible examples of Bitter coil designs incorporating multiple simultaneous changes, with FIGS. 22-23 shown in the same configuration as FIGS. 10-21 and with FIGS. 24-25 shown as the complete magneto-cumulative generator.

FIG. 22 shows a magneto-cumulative generator 30 wherein the windings 21 of the Bitter coil 20 have the inner and outer radii of the windings increase turn-by-turn, independent of all other dimensions, progressively along the length of the Bitter coil 20. This increasing “pagoda” design modifies the inductance profile of the stator 15a.

FIG. 23 shows a magneto-cumulative generator 30 wherein the windings 21 of the Bitter coil 20 have the inner and outer radii of the windings decrease turn-by-turn, independent of all other dimensions, progressively along the length of the Bitter coil 20. This decreasing “pagoda” design modifies the inductance profile of the stator 15a.

FIG. 24 shows a magneto-cumulative generator 30 wherein the windings 21 of the Bitter coil 20 have constant turn inner and outer radii, but progressively greater turn-by-turn thickness. The thickness of the insulation 23 between windings 21 varies in proportion to the thickness of the windings 21 also progressively increases turn-to-turn. This design increases the current and high voltage insulating capacity of the stator 15a.

FIG. 25 shows a magneto-cumulative generator 30 wherein the windings 21 of the Bitter coil 20 comprise hybrid windings 21, having a constant turn outer radius, and progressively smaller turn inner radius, along with a progressively greater turn-by-turn thickness along the Bitter coil 20, and progressively greater turn-to-turn insulation thickness. This design increases the current and high voltage capacity, and modifies the inductance profile of the stator 15a.

A Bitter coil stator 15a is substituted for the conventional solenoidal stator 15 in the magneto-cumulative generator 30 shown in FIG. 9. The advantages of using the Bitter coil 20 in the magneto-cumulative generator 30 are that it provides for increased inductance in the stator 15a. In principle, the cross-sectional area of round wire used to wind a solenoidal stator 15 can be obtained equivalently in a Bitter coil with thin disks of appropriately sized inner and outer radii. If the disks are thin enough (including insulation), a greater number of winding turns can be disposed along the same length of the stator 15a. Since inductance in a solenoid increases roughly as the number of turns squared, the stator inductance may be significantly increased using the present Bitter coil-type stator 15a.

Use of the Bitter coil 20 increases the dL/dt of the stator 15a during collapse. The time scale for collapsing the stator 15a depends primarily on the length of the armature 11 and the detonation velocity of the high explosive 13. By using the Bitter coil 20, the total inductance of the stator 15a is increased for the same winding length, and dL/dt is increased by the same factor as the inductance of the stator 15a.

Use of the Bitter coil 20 results in less flux lost through diffusion. The Bitter coil 20 presents a larger diffusion length in the radial direction for the magnetic field to penetrate and be lost, as compared with the diameter of wire in a solenoidal stator 15.

Use of the Bitter coil 20 results in less flux lost through insulating gaps between turns. A pair of adjacent windings 21 of the Bitter coil 20 represents a radial electromagnetic transmission line, which has cutoff frequencies for various modes except the TEM cylindrical mode. Magneto-cumulative generator time scales of operation are long enough, with low enough frequency components, that the separation of the windings 21 are in cutoff. For solenoid windings, however, the thickness of the wire may not present sufficient electromagnetic extinction length, thus permitting flux to escape. The larger radial extent of the Bitter coil 20 also helps here to establish sufficient extinction length. The allowable TEM mode couples into a time-varying azimuthal magnetic field which originates primarily from the return current in the armature 11. This means the ratio of azimuthal to nonazimuthal magnetic fields should be as low as possible. The added number of turns permitted by the Bitter coil 20 helps in this regard.

Use of the Bitter coil 20 results in less flux lost through clocking. For a Bitter coil 20, the conductive contact point between the expanding armature 11 and the stator 14 is not a point following the pitch of the stator winding, but provides almost complete 360° contact. This reduces openings through which flux can escape.

The use of the Bitter coil 20 also provides other advantages for the magneto-cumulative generator 30. For example, the Bitter coil 20 may have progressively greater turn-to-turn voltage insulation for the windings 21 of the stator 15a as the length of the stator 15a effectively shortens. The tum-to-turn insulating thickness can be modified for the same winding thickness. FIG. 19 shows a progressively increasing insulation 23 along the axis of the magneto-cumulative generator 30, but the insulation can be varied in any manner that can be fabricated.

The Bitter coil 20 may have progressively greater current-carrying capacity for the windings 21 of the stator 15a as the stator length effectively shortens. Turn-by-turn conductor thickness (and other dimensions) may be modified for the same thickness of insulation 23. FIG. 16 shows progressively thickening conductor disks 21 along the axis of the magneto-cumulative generator 30. The current within the magneto-cumulative generator 30 as the armature 11 begins its movement is comparable to the seed current, but output currents as the armature 11 finishes its movement are typically in the megampere range. A solenoidal stator winding can use wire sized for the maximum current, but this is clearly a waste of current capacity (and size) for the early upstream turns. A turn-by-turn increase in conductor disk thickness allows thin disks to be used for early upstream turns, and thick disks for later downstream turns, providing current-handling capability only where it is needed.

The present invention provides the ability to tailor the inductance profile of the stator 15a. FIG. 12 shows an example of a stator 15a with progressively smaller inner diameters for the conducting disks 21.

The present invention also provides the ability to vary the pitch of the windings of the stator 15a. FIG. 24 shows a hybrid of the Bitter coils 20 used in the magneto-cumulative generators 30 shown in FIGS. 16 and 19. In these Bitter coils 20, the thickness of both the conducting disks (windings 21) and insulation 23 increase progressively along the length of the stator 15a. FIG. 25 shows a hybrid of the Bitter coils 20 used in the magneto-cumulative generators 30 shown in FIGS. 12, 16, and 19, wherein the thickness and inner diameter of both the conducting disks (windings 21) and insulation 23 change progressively along the length of the stator 15a (the increasing diameter of the insulation 23 is not shown in the previous drawings).

Thus, magneto-cumulative generators employing improved Bitter coil-type stators have been disclosed. It is to be understood that the described embodiments are merely illustrative of some of the many specific embodiments which represent applications of the principles of the present invention. Clearly, numerous and other arrangements can be readily devised by those skilled in the art without departing from the scope of the invention.

What is claimed is:

1. A magneto-cumulative generator comprising:
(a) an armature having a conducting metal liner filled with high explosive;
(b) an initiator disposed at one end of the high explosive;
(c) a stator coaxially aligned with and surrounding the armature that comprises a Bitter coil, wherein the Bitter coil comprises:
(1) a plurality of disk-like windings interconnected by turn-to-turn connecting elements, and
(2) insulation disposed between the respective windings, the Bitter coil having tailorable windings and insulation that are tailored along the length of the armature to tailor the inductance profile of the Bitter coil;
(d) a switchable seed capacitor coupled between the Bitter coil and the initiator; and
(e) a load coupled between the armature and the Bitter coil.

2. The generator of claim 1 wherein the disk windings have a constant size and the insulation has a constant thickness.

3. The generator of claim 1 wherein the windings have an inner diameter, an outer diameter, and a thickness and wherein the insulation has a thickness, thereby providing four parameters, at least one of which is varied.

4. The generator of claim 3 wherein each of the four parameters may vary by decreasing, remaining the same, or increasing, thereby providing 3⁴, or 81, permutations.

5. The generator of claim 4 wherein the disk windings have constant turn inner and outer radii and progressively greater turn-by-turn thickness, and the insulation has a progressively thicker turn-to-turn thickness.

6. The generator of claim 4 wherein the disk windings have a constant turn outer radius, a progressively smaller turn inner radius, and a progressively greater turn thickness along the length of the Bitter coil, and the insulation has a progressively greater turn-to-turn thickness.
